(19) United States
(12) Patent Application Publication
(10) Pub. No.: US 2023/0276341 A1
(43) Pub. Date: Aug. 31, 2023

(54) ACCESS CONTROL DIFFERENTIATION FOR MISSION CRITICAL COMMUNICATION DEVICES AND/OR SERVICES

(71) Applicant: Telefonaktiebolaget LM Ericsson (publ), Stockholm (SE)

(72) Inventors: Jingya LI, GÖTEBORG (SE); Henrik SAHLIN, MÖTEBORG (SE); Joakim ÅKESSON, Landvetter (SE)

(73) Assignee: Telefonaktiebolaget LM Ericsson (publ), Stockholm (SE)

(21) Appl. No.: 17/921,559

(22) PCT Filed: Apr. 19, 2021
(86) PCT No.: PCT/EP2021/060031

§ 371 Date: Oct. 26, 2022

Related U.S. Application Data
(60) Provisional application No. 63/015,822, filed on Apr. 27, 2020.

(51) Int. Cl. H04W 48/02; H04W 76/10

(52) U.S. Cl. CPC H04W 48/02; H04W 76/10

(57) ABSTRACT

A method (200) for configuring UEs. The method includes assigning (s202) a first access identity number to a first mission critical, MC, UE (102). The method also includes assigning (s204) a second access identity number to a second MC UE. The first access identity number is different than the second access identity number.

### CROSS-REFERENCE TO RELATED APPLICATIONS

This application is a 35 U.S.C. § 371 National Stage of International Patent Application No. PCT/EP2021/060031, filed Apr. 19, 2021, which claims priority to U.S. provisional patent application No. 63/015,822, filed on Apr. 27, 2020. The above identified applications are incorporated by this reference.

### TECHNICAL FIELD

Disclosed are embodiments related to access control for mission critical (MC) communication devices and/or services.

### BACKGROUND

Before a user equipment (UE) (i.e., a communication device capable of communicating wirelessly with an access point (e.g., a base station)) can properly communicate within another communication device (e.g., a server), the UE must perform what is known as “cell search” to find, identify, and synchronize with a cell served by an access point. Then, the UE must acquire basic system information, and perform an access barring check to determine whether or not the UE is allowed to use the cell for network connectivity. If the access is allowed, the UE will then perform what is known as a “random access” (RA) procedure to establish a connection (e.g., a Radio Resource Control (RRC) connection) with the access point. Examples of UEs include: smartphones, sensors, appliances, meters, computers, servers, etc.

1. New Radio (NR) Cell Search and System Information Acquisition

In NR, the combination of a synchronization signal (SS) and a physical broadcast channel (PBCH) is referred to as a SS/PBCH block (SSB). Similar to LTE, a pair of synchronization signals (i.e., a primary synchronization signal (PSS) and secondary synchronization signal (SSS)), is periodically transmitted on downlink from each cell to allow a UE to initially access to the network. By detecting a SS, a UE can obtain the physical cell identity, achieve downlink synchronization in both time and frequency, and acquire the timing for the PBCH.

The PBCH carries a master information block (MIB), which contains system information from which the UE can know if the cell is barred and the info on how to acquire system information block 1 (SIB1). This SIB1 carries the additional system information that is needed for a UE to be able to perform access barring control and the subsequent random access procedure if the access request can be sent.

2. NR Unified Access Control

Before sending any connection request to base station (e.g., gNB), a UE shall evaluate the cell reservation and access restriction related information contained in SIB1 to check whether a connection request for the access attempt should be barred or not. This is done by the Unified Access Control (UAC) mechanism specified in 5G.

The UE maps its access attempt to an access category and one or more access identities. The access identities and access categories are defined in Table 1 (copied from Table 4.5.2.1 in 3GPP TS 24.501 v16.3.0) and Table 2 (copied form Table 4.5.2.2 in TS 24.501 v16.3.0), respectively. The information on cell access restrictions associated with access categories and access identities is broadcast in SIB 1. Based on this information received from SIB1, the UE determines whether an access attempt is authorized for the selected Public Land Mobile Network (PLMN), and the associated access category and access identity(ies) for the access attempt.

This UAC mechanism can effectively reduce the amount of traffic accessing the network shortly after SIB1 broadcasting. It also avoids an increase in network processing load because connection requests are barred, meaning that no connection request will be sent from the UE to the gNB.

TABLE 1

| Access | |
|---|---|
| Identity | |
| number | UE configuration |
| 0 | UE is not configured with any parameters from this table |
| 1 (NOTE 1) | UE is configured for multimedia priority service (MPS). |
| 2 (NOTE 2) | UE is configured for mission critical service (MCS). |
| 3-10 | Reserved for future use |
| 11 (NOTE 3) | Access Class 11 is configured in the UE. |
| 12 (NOTE 3) | Access Class 12 is configured in the UE. |
| 13 (NOTE 3) | Access Class 13 is configured in the UE. |
| 14 (NOTE 3) | Access Class 14 is configured in the UE. |
| 15 (NOTE 3) | Access Class 15 is configured in the UE. |

(NOTE 1):
Access identity 1 is valid when:
the USIM file EF_{UAC}_{_{—}}_{AIC} indicates the UE is configured for access identity 1 and the selected PLMN, if a new PLMN is selected, or RPLMN is the HPLMN (if the EHPLMN list is not present or is empty) or EHPLMN (if the EHPLMN list is present), or a visited PLMN of the home country (see the definition of home country in 3GPP TS 24.301 [15]); or
the UE receives the 5GS network feature support IE with the MPS indicator bit set to “Access identity 1 valid” from the RPLMN as described in subclause 5.5.1.2.4 and subclause 5.5.1.3.4.
(NOTE 2):
Access identity 2 is used by UEs configured for MCS and is valid when:
the USIM file EF_{UAC}_{_{—}}_{AIC} indicates the UE is configured for access identity 2 and the selected PLMN, if a new PLMN is selected, or RPLMN is the HPLMN (if the EHPLMN list is not present or is empty) or EHPLMN (if the EHPLMN list is present), or a visited PLMN of the home country (see 3GPP TS 23.122 [5]); or
the UE receives the 5GS network feature support IE with the MCS indicator bit set to “Access identity 2 valid” from the RPLMN as described in subclause 5.5.1.2.4 and subclause 5.5.1.3.4.
(NOTE 3):
Access identities 11 and 15 are valid in HPLMN (if the EHPLMN list is not present or is empty) or EHPLMN (if the EHPLMN list is present).
Access Identities 12, 13 and 14 are valid in HPLMN and visited PLMNs of home country only (see the definition of home country in 3GPP TS 24.301 [15]).

TABLE 2

| | Type of access | | Access |
|---|---|---|---|
| Rule # | attempt | Requirements to be met | Category |
| 1 | Response to | Access attempt is for MT access, | 0 (=MT_acc) |
| | paging or | or handover of ongoing MMTEL | |
| | NOTIFICATION | voice call, MMTEL video call or | |
| | over non-3GPP | SMSoIP from non-3GPP access | |
| | access; | | |
| | 5GMM connection | | |
| | management | | |
| | procedure initiated | | |
| | for the purpose of | | |
| | transporting an LPP | | |
| | message without | | |
| | an ongoing 5GC- | | |
| | MO-LR procedure; | | |
| | Access attempt to | | |
| | handover of | | |
| | ongoing MMTEL | | |
| | voice call, MMTEL | | |
| | video call or | | |
| | SMSoIP from non- | | |
| | 3GPP access | | |
| 2 | Emergency | UE is attempting access for an | 2 (=emergency) |
| | | emergency session (NOTE 1, | |
| | | NOTE 2) | |
| 3 | Access attempt for | UE stores operator-defined | 32-63 |
| | operator-defined | access category definitions valid | (=based on |
| | access category | in the current PLMN as specified | operator |
| | | in subclause 4.5.3, and access | classification) |
| | | attempt is matching criteria of an | |
| | | operator-defined access | |
| | | category definition | |
| 4 | Access attempt for | (a) UE is configured for | 1 (=delay |
| | delay tolerant | NAS signalling low priority or UE | tolerant) |
| | service | supporting S1 mode is | |
| | | configured for EAB (see the | |
| | | “ExtendedAccessBarring” leaf of | |
| | | NAS configuration MO in | |
| | | 3GPP TS 24.368 [17] or | |
| | | 3GPP TS 31.102 [22]) where | |
| | | “EAB override” does not apply, | |
| | | and | |
| | | (b): the UE received | |
| | | one of the categories a, b or c as | |
| | | part of the parameters for unified | |
| | | access control in the broadcast | |
| | | system information, and the UE | |
| | | is a member of the broadcasted | |
| | | category in the selected PLMN or | |
| | | RPLMN/equivalent PLMN | |
| | | (NOTE 3, NOTE 5, NOTE 6, | |
| | | NOTE 7, NOTE 8) | |
| 4.1 | MO IMS registration | Access attempt is for MO IMS | 9 (=MO |
| | related signalling | registration related signalling | IMS |
| | | (e.g. IMS initial registration, re- | registration |
| | | registration, subscription refresh) | related |
| | | or for NAS signalling connection | signalling) |
| | | recovery during ongoing | |
| | | procedure for MO IMS | |
| | | registration related signalling | |
| | | (NOTE 2a) | |
| 5 | MO MMTel voice | Access attempt is for MO MMTel | 4 (=MO |
| | call | voice call | MMTel |
| | | or for NAS signalling connection | voice) |
| | | recovery during ongoing MO | |
| | | MMTel voice call (NOTE 2) | |
| 6 | MO MMTel video | Access attempt is for MO MMTel | 5 (=MO |
| | call | video call | MMTel |
| | | or for NAS signalling connection | video) |
| | | recovery during ongoing MO | |
| | | MMTel video call (NOTE 2) | |
| 7 | MO SMS over NAS | Access attempt is for MO SMS | 6 (=MO |
| | or MO SMSoIP | over NAS (NOTE 4) or MO SMS | SMS and |
| | | over SMSoIP transfer | SMSoIP) |
| | | or for NAS signalling connection | |
| | | recovery during ongoing MO | |
| | | SMS or SMSoIP transfer | |
| | | (NOTE 2) | |
| 8 | UE NAS initiated | Access attempt is for MO | 3 (=MO_sig) |
| | 5GMM specific | signalling | |
| | procedures | | |
| 8.1 | Mobile originated | Access attempt is for mobile | 3 (=MO_sig) |
| | location request | originated location request | |
| | | (NOTE 9) | |
| 8.2 | Mobile originated | Access attempt is for mobile | 3 (=MO_sig) |
| | signalling | originated signalling transaction | |
| | transaction towards | towards the PCF (NOTE 10) | |
| | the PCF | | |
| 9 | UE NAS initiated | Access attempt is for MO data | 7 (=MO_data) |
| | 5GMM connection | | |
| | management | | |
| | procedure or | | |
| | 5GMM NAS | | |
| | transport procedure | | |
| 10 | An uplink user data | No further requirement is to be | 7 (=MO_data) |
| | packet is to be sent | met | |
| | for a PDU session | | |
| | with suspended | | |
| | user-plane | | |
| | resources | | |

(NOTE 1):
This includes 5GMM specific procedures while the service is ongoing and 5GMM connection management procedures required to establish a PDU session with request type = “initial emergency request” or “existing emergency PDU session”, or to re-establish user-plane resources for such a PDU session. This further includes the service request procedure initiated with a SERVICE REQUEST message with the Service type IE set to “emergency services fallback”.
(NOTE 2):
Access for the purpose of NAS signalling connection recovery during an ongoing service as defined in subclause 4.5.5, or for the purpose of NAS signalling connection establishment following fallback indication from lower layers during an ongoing service as defined in subclause 4.5.5, is mapped to the access category of the ongoing service in order to derive an RRC establishment cause, but barring checks will be skipped for this access attempt.
(NOTE 2a):
Access for the purpose of NAS signalling connection recovery during an ongoing procedure for MO IMS registration related signalling as defined in subclause 4.5.5, or for the purpose of NAS signalling connection establishment following fallback indication from lower layers during an ongoing procedure for MO IMS registration related signalling as defined in subclause 4.5.5, is mapped to the access category of the MO IMS registration related signalling in order to derive an RRC establishment cause, but barring checks will be skipped for this access attempt.
(NOTE 3):
If the UE selects a new PLMN, then the selected PLMN is used to check the membership; otherwise the UE uses the RLPMN or a PLMN equivalent to the RPLMN.
(NOTE 4):
This includes the 5GMM connection management procedures triggered by the UE-initiated NAS transport procedure for transporting the MO SMS.
(NOTE 5):
The UE configured for NAS signalling low priority is not supported in this release of specification. If a UE supporting both S1 mode and N1 mode is configured for NAS signalling low priority in S1 mode as specified in 3GPP TS 24.368 [17] or 3GPP TS 31.102 [22], the UE shall ignore the configuration for NAS signalling low priority when in N1 mode.
(NOTE 6):
If the access category applicable for the access attempt is 1, then the UE shall additionally determine a second access category from the range 3 to 7. If more than one access category matches, the access category of the lowest rule number shall be chosen. The UE shall use the second access category only to derive an RRC establishment cause for the access attempt.
(NOTE 7):
“EAB override” does not apply, if the UE is not configured to allow overriding EAB (see the “Override_ExtendedAccessBarring” leaf of NAS configuration MO in 3GPP TS 24.368 [17] or 3GPP TS 31.102 [22]), or if NAS has not received an indication from the upper layers to override EAB and the UE does not have a PDU session that was established with EAB override.
(NOTE 8):
For the definition of categories a, b and c associated with access category 1, see 3GPP TS 22.261 [3]. The categories associated with access category 1 are distinct from the categories a, b and c associated with EAB (see 3GPP TS 22.011 [1A]).
(NOTE 9):
This includes:
a) the UE-initiated NAS transport procedure for transporting a mobile originated location request;
b) the 5GMM connection management procedure triggered by a) above; and
c) NAS signalling connection recovery during an ongoing 5GC-MO-LR procedure.
(NOTE 10):
This includes:
a) the UE-initiated NAS transport procedure for transporting a mobile originated signalling transaction towards the PCF;
b) the 5GMM connection management procedure triggered by a) above; and
c) NAS signalling connection recovery during an ongoing UE triggered V2X policy provisioning procedure.

3. NR Random Access (RA) Procedure

If an access attempt is permitted, the UE performs an RA procedure (e.g., the 4-step RA procedure) to establish an RRC connection to the gNB. During the RA procedure the UE will transmit an RRCSetupRequest message. The information elements (IEs) included in the RRCSetupRequest message are defined in 3GPP TS 38.331 and shown below in Table 3.

TABLE 3
RRCSetupRequest message

-- ASN1START
-- TAG-RRCSETUPREQUEST-START
RRCSetupRequest ::= SEQUENCE {
rrcSetupRequest RRCSetupRequest-IEs
}
RRCSetupRequest-IEs ::= SEQUENCE {

| | |
|---|---|
| ue-Identity | InitialUE-Identity, |
| establishmentCause | EstablishmentCause, |
| spare | BIT STRING (SIZE (1)) |
| } | |

InitialUE-Identity ::= CHOICE {

| | |
|---|---|
| ng-5G-S-TMSI-Part1 | BIT STRING (SIZE (39)), |
| randomValue | BIT STRING (SIZE (39)) |

}
EstablishmentCause ::= ENUMERATED {emergency, highPriorityAccess,
mt-Access, mo-Signalling, mo-Data, mo-VoiceCall, mo-VideoCall,
mo-SMS, mps-PriorityAccess, mcs-PriorityAccess, spare6, spare5, spare4,
spare3, spare2, spare1}
-- TAG-RRCSETUPREQUEST-STOP

The establishmentCause IE contained in this RRCSetupRequest message indicates the reason for the connection establishment request, e.g., “emergency” for emergency calls, “mps-PriorityAccess” for multimedia-priority UEs and “mcs-PriorityAccess” for Mission Critical UEs, etc.

A UE sets the establishmentCause based on the configured access identities/access categories. The mapping between access categories/access identities and RRC establishment causes are shown in Table 4 below (copied from Table 4.5.6.1 of 3GPP TS 24.501 v16.3.0). A gNB identifies the type of connection request from a UE by decoding the establishmentCause, based on which, the gNB decides whether to accept the RRC connection request or to reject the request with RRCConectionReject. For instance, in a mission critical situation where the network is highly loaded, to guarantee the QoS for MC UEs (i.e., UEs configured for MC services) a gNB can prioritize the connection establishment for MC UEs and reject the requests from non-MC UEs.

TABLE 4
Mapping table for access identities/access
categories and RRC establishment cause

| | Access | | RRC establishment |
|---|---|---|---|
| Rule # | identities | Access categories | cause is set to |
| 1 | 1 | Any category | mps-PriorityAccess |
| 2 | 2 | Any category | mcs-PriorityAccess |
| 3 | 11, 15 | Any category | highPriorityAccess |
| 4 | 12, 13, 14, | Any category | highPriorityAccess |
| 5 | 0 | 0 (=MT_acc) | mt-Access |
| | | 1 (=delay tolerant) | Not applicable (NOTE 1) |
| | | 2 (=emergency) | emergency |
| | | 3 (=MO_sig) | mo-Signalling |
| | | 4 (=MO MMTel voice) | mo-VoiceCall |
| | | 5 (=MO MMTel video) | mo-VideoCall |
| | | 6 (=MO SMS and | mo-SMS |
| | | SMSoIP) | |
| | | 7 (=MO_data) | mo-Data |
| | | 9 (=MO IMS registration | mo-Data |
| | | related signalling) | |

(NOTE 1):
A UE using access category 1 for the access barring check will determine a second access category in the range 3 to 7 that is to be used for determination of the RRC establishment cause. See subclause 4.5.2, table 4.5.2.2, NOTE 6.
NOTE 2:
See subclause 4.5.2, table 4.5.2.1 for use of the access identities of 0, 1, 2, and 11-15.

### SUMMARY

Certain challenges presently exist. For instance, in some mission critical (MC) situations, not all MC UEs and/or MC services should be treated equally. For example, an access request from a UE that is being used by a commander in charge of coordinating several different groups of first responders may need higher priority than an access request transmitted by a UE being used by one of the first responders. That is, for example, the access requests from different MC UEs need to be treated with different priorities based on their operation roles, the importance of the data or services to be transmitted over the network, etc. According to the NR Rel-16 standard, all MC UEs are configured with access identity 2, which means that during initial access, the establishmentCause for all MC UEs will be set to mcs-PriorityAccess. This implies that a network node can't differentiate between different MC UEs (e.g., can't differentiate between a first MC UE that is attempting to invoke a first MC service and a second MC UE attempting to invoked a second MC service that has a lower priority than the first MC service). Thus, the network node (e.g., gNB) cannot perform differentiated access control during initial access phase.

Accordingly, in one aspect there is provided a method performed by a network node for configuring UEs. The method includes assigning a first access identity number to a first mission critical (MC) UE. The method also includes assigning a second access identity number to a second MC UE. The first access identity number is different than the second access identity number.

In another aspect, there is provided a method performed by a network node for configuring a UE. The method includes configuring the UE with an access identity number reserved for UEs configured for mission critical services (MCSs). The method also includes configuring the UE with a first rule that maps a first tuple comprising the access identity number and a first access category identifier to a first RRC establishment cause value. The method also includes configuring the UE with a second rule that maps a second tuple comprising the access identity number and a second access category identifier to a second RRC establishment cause value. The second access category identifier is different than the first access category identifier, and the second RRC establishment cause value is different than the first RRC establishment cause value.

In another aspect there is provided a method performed by a UE. The method includes the UE storing an access identity number, wherein the access identity number is reserved for UEs configured for an MCS. The method also includes the UE storing a first rule that maps a first tuple comprising the access identity number and a first access category identifier to a first Radio Resource Control, RRC, establishment cause value. The method also includes the UE storing a second rule that maps a second tuple comprising the access identity number and a second access category identifier to a second RRC establishment cause value. The second access category identifier is different than the first access category identifier, and the second RRC establishment cause value is different than the first RRC establishment cause value.

In another aspect there is provided a computer program comprising instructions which when executed by processing circuitry of a network node causes the network node to perform any one of the network node methods disclosed herein. In another aspect there is provided a carrier containing the computer program, wherein the carrier is one of an electronic signal, an optical signal, a radio signal, and a computer readable storage medium. In another aspect there is provided a network node, where the network node is configured to perform any one of the network node methods disclosed herein. In some embodiments, the network node includes processing circuitry and a memory containing instructions executable by the processing circuitry, whereby the network node is configured to perform any one of the network methods disclosed herein.

In another aspect there is provided a computer program comprising instructions which when executed by processing circuitry of a UE causes the UE to perform any one of the UE methods disclosed herein. In another aspect there is provided a carrier containing the computer program, wherein the carrier is one of an electronic signal, an optical signal, a radio signal, and a computer readable storage medium. In another aspect there is provided a UE, where the UE is configured to perform any one of the UE methods disclosed herein. In some embodiments, the UE includes processing circuitry and a memory containing instructions executable by the processing circuitry, whereby the UE is configured to perform any one of the network methods disclosed herein.

The aspects and embodiments disclosed herein are advantageous in that they enable that different MC UEs can use different establishment causes when attempting to establish an RRC connection. By enabling a differentiation among different MC UEs and/or MC services in establishment causes, this allows the network node to apply a different admission control at an early stage. Therefore, in an extreme network load situation, a network node can, for example, prioritize the more important MC services to access to the network first. In addition, the network node can utilize the information to predict the network load and the demanded additional resources, so that it can make better decisions on the load balancing, traffic management and queuing mechanism after an RRC connection has been established.

### BRIEF DESCRIPTION OF THE DRAWINGS

The accompanying drawings, which are incorporated herein and form part of the specification, illustrate various embodiments.

FIG. 1 illustrates a RA procedure according to an embodiment.

FIG. 2 is a flowchart illustrating a process according to some embodiments.

FIG. 3 is a flowchart illustrating a process according to some embodiments.

FIG. 4 is a flowchart illustrating a process according to some embodiments.

FIG. 5 illustrates a network node according to some embodiments.

FIG. 6 illustrates a UE according to some embodiments.

### DETAILED DESCRIPTION

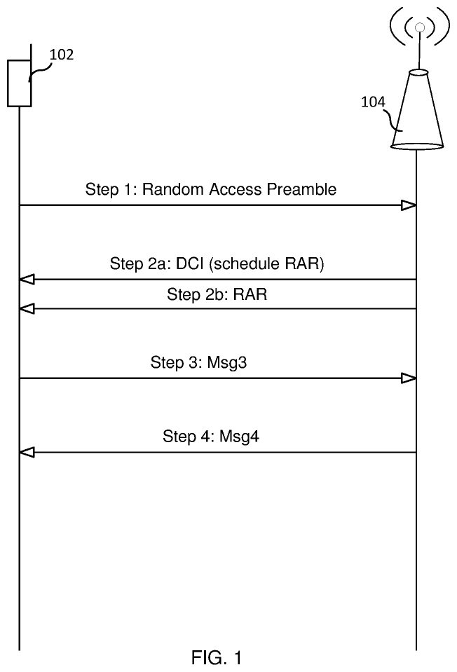

FIG. 1 illustrates a random access (RA) procedure being performed by a UE 102. That RA procedure is used by UEs to establish a connection (e.g., a Radio Resource Control (RRC) connection) with a network node 104 (e.g., an access point, which is also known as a base station). The RA procedure shown in FIG. 1 is the 4-step RA procedure, also referred to as the Type-1 random access procedure in 3GPP TS 38.213, but other RA procedures exist (e.g., the 2-step RA procedure). In a first step, UE 102 initiates the RA procedure by transmitting a random-access preamble (RAP) (a.k.a., “Message 1” or “Msg 1”) on the Physical Random Access Channel (PRACH). After detecting the Msg1, the network node 104 (e.g., a 5G base station (gNB)) responds by transmitting to the UE on the Physical Downlink Control Channel (PDCCH) Downlink Control Information (DCI) (e.g., DCI format 1_0) to prepare the UE to receive a random-access response (RAR) (a.k.a., “Message 2” or “Msg2”) and then sends the RAR on the Physical Downlink Shared Channel (PDSCH). In the third step, after successfully decoding Msg2, the UE 102 continues the procedure by transmitting a message (a.k.a., “Message 3” or “Msg3”) on the Physical Uplink Shared Channel (PUSCH). Msg3 is or contains an RRC connection establishment request. In the last step of the procedure, the gNB transmits a message (a.k.a., “Message 4” or “Msg4”) on the Physical Downlink Shared Channel (PDSCH) for contention resolution. Msg3 includes a rrcSetupRequest message, which contains the establishmentCause Information Element (IE) which contains a value indicating the reason that caused the UE 102 to initiate the connection establishment, e.g., emergency call, mission critical services, multimedia priority services, etc. The network node 104 identifies the type of connection request being requested by UE 102 by decoding the establishmentCause IE received in msg3, based on which, the network node 104 decides whether this request shall be admitted or rejected, based on the network traffic load situation and available resource in the network.

In many mission critical (MC) situations, the access requests from different MC UEs need to be treated with different priorities based on their operation roles, the importance of the data or services to be transmitted over the network, etc. For example, a central commander who coordinates the mission critical actions of a first responder group needs to be configured with a relatively higher priority, the first responders can be configured with a relatively lower priority. As another example, one MC UE group operating in a life-threatening situation needs to be configured with a higher priority, and the other MC UE groups can be configured with a relatively lower priority, even if they are all using the same service. Yet another example, an MC UE (e.g., a MC drone fleet leader or a MC rely device) that has a centralized decision or coordination role for the other MC devices may need to be configured with a relatively higher priority.

Accordingly, more than one RRC establishment cause is defined for MC UEs and/or MC services so that the network can distinguish between different MC UEs and/or MC services. Different methods of defining a more than one RRC establishment causes for MC UE/services are defined. Note that the examples focus on MC services, but the same methodology can be applied to other services, e.g., multimedia priority services.

1. Using Existing Access Identities

In this embodiment, existing establishment causes and access identities specified in 3GPP standard are utilized. This can be achieved by, for example, configuring one group of MC UEs (e.g., higher priority MC UEs) with Access Identity 2, and the configuring another group of MC UEs (e.g., lower priority MC UEs) with Access Identity 11, 12, 13, 14, or 15. That is, for example, when configuring an MC UE, a network operator can select an access identity for the MC UE from a set of two or more access identities (e.g., a set comprising the following access identities: 2, 11, 12, 13, 14, and 15), whereas today the network operator has no choice but to select the same access identity for all MC UEs (i.e., access identity 2).

Based on Table 4, the access attempts from higher priority MC UEs will be mapped to the establishment cause “mcs-PriorityAccess,” and the access attempts from lower priority MC UEs will be mapped to the establishment cause “highPriorityAccess.” A network node can prioritize between MC UEs mapped to “mcs-PriorityAccess” and MC UEs mapped to “highPrioirtyAccess,” depending on the current network load situation and the resource utilization status. That is, for example, an MC UE that uses “mcs-PriorityAccess” as the establishment cause can be given more resources than an MC UE that uses “highPriorityAccess” as the establishment cause.

In one embodiment, all MC UEs are provisioned with access identities from the value set {11, 12, 13, 14, 15} on their SIM/USIM card, and the core network can assign access identity 2 to UEs configured with higher priority mission critical services before these UEs apply access control.

This alternative utilizes the existing standardized differentiation indicators, and it can support differentiation between MC UEs base on, for example, their operation roles. A drawback of this method is that it is not possible for a network to acquire service type information of MC UEs, so prioritization for a certain type of MC service cannot be supported during initial access phase. Another drawback of this method is that the operator needs to make sure that the access identities from the value set {11, 12, 13, 14, 15} are not configured for non-MC UEs, otherwise the network node will not be able to distinguish between these non-MC UEs and the MC UEs whose access requests are mapped to “highPriorityAccess.” Yet another drawback of this method is that the network can have only up to two levels of priorities used between MC UEs, one mapped to “highPriorityAccess”, and the other one mapped to “mcs-PriorityAccess.”

2. New Establishment Cause(s)

In another embodiment one or more new establishment causes are defined. For example, in one embodiment, at least one new establishment cause is defined to provide more than one RRC establishment causes sent by different MC UEs. The additional establishment cause can be defined by using one of the six spared parameters that have not been defined for the establishmentCause field.

TABLE 5

```
EstablishmentCause ::= ENUMERATED {
  emergency, highPriorityAccess, mt-Access, mo-Signalling,
  mo-Data, mo-VoiceCall, mo-VideoCall, mo-SMS,
  mps-PriorityAccess, mcs-PriorityAccess, spare6, spare5,
  spare4, spare3, spare2, spare1
}
```

As a UE sets the establishmentCause based on the configured access identities/access categories, new mapping rules need to be added in the mapping table for access identities/access categories and RRC establishment cause to support a newly added establishment cause in the rrcSetupRequest message.

2.1 Define a New Access Identity Value for MC UEs

In one embodiment at least one new access identity value (e.g., 3) is defined for certain MC UEs. MC UEs configured with access identity 2 and MC UEs configured with the new access identity value (e.g., 3) may have different access priorities.

In one embodiment, the new access identity value is any value in the set of values 3-10 that are currently reserved for future use.

Table 6 and Table 7 give an example on the way of adding an additional establishment cause for differentiating MC UEs by defining a new access identity for MC UEs and modifying the mapping table for access identities/access categories and RRC establishment cause accordingly.

TABLE 6
Modified Access Identities

| Access | |
|---|---|
| Identity | |
| number | UE configuration |
| 0 | UE is not configured with any parameters from this table |
| 1 (NOTE 1) | UE is configured for multimedia priority service (MPS) |
| 2 (NOTE 2) | UE is configured for mission critical service (MCS) with |
| | priority level 1 |
| 3 | UE is configured for mission critical service (MCS) with |
| | priority level 2 |
| 4-10 | Reserved for future use |
| 11 (NOTE 3) | Access Class 11 is configured in the UE. |
| 12 (NOTE 3) | Access Class 12 is configured in the UE. |
| 13 (NOTE 3) | Access Class 13 is configured in the UE. |
| 14 (NOTE 3) | Access Class 14 is configured in the UE. |
| 15 (NOTE 3) | Access Class 15 is configured in the UE. |

TABLE 7
Modified mapping table for access identities/access categories
and RRC establishment cause (new access identities)

| | Access | | RRC establishment |
|---|---|---|---|
| Rule # | identities | Access categories | cause is set to |
| 1 | 1 | Any category | mps-PriorityAccess |
| 2 | 2 | Any category | mcs-PriorityAccess |
| 3 | 11, 15 | Any category | highPriorityAccess |
| 4 | 12, 13, 14, | Any category | highPriorityAccess |
| 5 | 0 | 0 (=MT_acc) | mt-Access |
| | | 1 (=delay tolerant) | Not applicable |
| | | | (NOTE 1) |
| | | 2 (=emergency) | emergency |
| | | 3 (=MO_sig) | mo-Signalling |
| | | 4 (=MO MMTel | mo-VoiceCall |
| | | voice) | |
| | | 5 (=MO MMTel | mo-VideoCall |
| | | video) | |
| | | 6 (=MO SMS and | mo-SMS |
| | | SMSoIP) | |
| | | 7 (=MO_data) | mo-Data |
| | | 9 (=MO IMS | mo-Data |
| | | registration related | |
| | | signalling) | |
| 6 | 3 | Any category | mcs-Priority Access- |
| | | | level2 |

As can be seen by comparing Table 6 with Table 1, a new UE configuration and corresponding access identity (i.e., 3) has been added to the table provide an access identity for lower priority MC UEs, and as can be seen by comparing Table 7 with Table 4, a new rule (i.e., Rule 6) has been added to the table for MC UEs having an access identity of 3.

Because a dedicated access identity is standardized for MC UEs, the network can utilize one or more additional access identities (e.g., 3-10) together with the already specified access identity (i.e., 2) to differentiate between MC UEs configured with different priority MC services, without preventing using access identities 11-15 for other users with “highPriorityAccess”.

2.2: Define new standardized access categories for MC Services

In an embodiment, at least a new access category is standardized for differentiating different MC services during the initial access phase, and at least a new rule is defined for mapping the type of access attempt for the new access category.

In an embodiment, a new standardized access category in combination with the legacy access identity (i.e., access identity 2) is mapped to a new RRC establishment cause.

Table 8 and Table 9 give an example of additional establishment causes for differentiating MC Services by defining at least a few new access categories for MC Services and modifying the mapping table for access identities/access categories and RRC establishment cause accordingly. For example, as shown in Table 8, new access categories 10-13 are introduced.

In the example shown in Table 9, access identity 2 is used in combination with a set of new standardized access categories (i.e., 10-13 in this example) to obtain a set of new RRC establishment causes. Note that the legacy Rel-15/16 MC UEs will follow the legacy mapping table (Table 4), as the new release MC UEs and legacy MC UEs will have different RRC establishment cause values, the network node can distinguish the legacy MC UEs and new release MC UEs, therefore, no impact on legacy MC UE operations.

TABLE 8
Part of modified Mapping Table for access categories

| | Type of access | | |
|---|---|---|---|
| Rule # | attempt | Requirements to be met | Access Category |
| 1 | Response to paging; | Access attempt is for MT access, | 0 (=MT_acc) |
| | 5GMM connection | or handover of ongoing MMTEL | |
| | management | voice call, MMTEL video call or | |
| | procedure initiated for | SMSoIP from non-3GPP access | |
| | the purpose of | | |
| | transporting an LPP | | |
| | message without an | | |
| | ongoing 5GC-MO-LR | | |
| | procedure; | | |
| | Access attempt to | | |
| | handover of MMTEL | | |
| | voice call, MMTEL | | |
| | video call or SMSoIP | | |
| | from non-3GPP access | | |
| 2 | Emergency | UE is attempting access for an | 2 (=emergency) |
| | | emergency session (NOTE 1, | |
| | | NOTE 2) | |
| . . . | . . . | . . . | . . . |
| 10 | An uplink user data | No further requirement is to be | 7 (=MO_data) |
| | packet is to be sent for | met | |
| | a PDU session with | | |
| | suspended user-plane | | |
| | resources | | |
| 11 | Moblie originated MC | Access attempt is for MCPTT | 10 (MCPTT) |
| | PTT call | | |
| 12 | Moblie originated MC | Access attempt is for MCData | 11 (MCData) |
| | Data | | |
| 13 | Moblie originated MC | Access attempt is for MCVideo | 12 (MCVideo) |
| | video call, MC video | | |
| | streaming | | |
| 14 | Mobile originated | Access attempt is for important | 13 |
| | location request for | MC signaling e.g., for request for | (MC_signaling) |
| | MC services | critical location information | |
| 15 | Mobile originated MC | Access attempt is for important | 13 |
| | control signalling | MC control signaling to coordinate | (MC_signaling) |
| | | or assist connection establishment | |
| | | for another MC UE | |

TABLE 9
Modified mapping table for access identities/access categories
and RRC establishment cause (new access categories)

| | Access | | RRC establishment |
|---|---|---|---|
| Rule # | identities | Access categories | cause is set to |
| 1 | 1 | Any category | mps-Priority Access |
| 2 | 2 | Any category except | mcs-PriorityAccess |
| | | for the newly | |
| | | standardized | |
| | | categories for MC | |
| | | services | |
| 3 | 11, 15 | Any category | highPriorityAccess |
| 4 | 12, 13, 14, | Any category | highPriorityAccess |
| 5 | 0 | 0 (=MT_acc) | mt-Access |
| | | 1 (=delay tolerant) | Not applicable |
| | | | (NOTE 1) |
| | | 2 (=emergency) | emergency |
| | | 3 (=MO_sig) | mo-Signalling |
| | | 4 (=MO MMTel | mo-VoiceCall |
| | | voice) | |
| | | 5 (=MO MMTel | mo-VideoCall |
| | | video) | |
| | | 6 (=MO SMS and | mo-SMS |
| | | SMSoIP) | |
| | | 7 (=MO_data) | mo-Data |
| | | 9 (=MO IMS | mo-Data |
| | | registration related | |
| | | signalling) | |
| 6 | 2 | Category 10 | mcs-PriorityAccess- |
| | | (MCPTT) | PTT |
| 7 | 2 | Category 11 | mcs-PriorityAccess- |
| | | (MCData) | Data |
| 8 | 2 | Category 12 | mcs-PriorityAccess- |
| | | (MCVideo) | Video |
| 9 | 2 | Category 13 | mcs-PriorityAccess- |
| | | (MC_signaling) | signaling |

In an embodiment, a new standardized access category in combination with a new access identity (i.e., different from access identity 2) is mapped to a new RRC establishment cause.

In another example as shown in Table 10, a new access identity (access identity 3) is used together with a set of new access categories (e.g., 10-13) to define a set of new RRC establishment causes. Note that the legacy Rel-15/16 MC UEs will follow the legacy mapping table (Table 4), as the new release MC UEs and legacy MC UEs will have different RRC establishment cause values, the network node can distinguish the legacy MC UEs and new release MC UEs, therefore, no impact on legacy MC UE operations.

TABLE 10
Modified mapping table for access identities/access
categories and RRC establishment cause (new access
identities and new access categories)

| | Access | | RRC establishment |
|---|---|---|---|
| Rule # | identities | Access categories | cause is set to |
| 1 | 1 | Any category | mps-PriorityAccess |
| 2 | 2 | Any category | mcs-PriorityAccess |
| 3 | 11, 15 | Any category | highPriorityAccess |
| 4 | 12, 13, 14, | Any category | highPriorityAccess |
| 5 | 0 | 0 (=MT_acc) | mt-Access |
| | | 1 (=delay tolerant) | Not applicable |
| | | | (NOTE 1) |
| | | 2 (=emergency) | emergency |
| | | 3 (=MO_sig) | mo-Signalling |
| | | 4 (=MO MMTel | mo-VoiceCall |
| | | voice) | |
| | | 5 (=MO MMTel | mo-VideoCall |
| | | video) | |
| | | 6 (=MO SMS and | mo-SMS |
| | | SMSoIP) | |
| | | 7 (=MO_data) | mo-Data |
| | | 9 (=MO IMS | mo-Data |
| | | registration related | |
| | | signalling) | |
| 6 | 3 | Category 10 | mcs-PriorityAccess- |
| | | (MCPTT) | PTT |
| 7 | 3 | Category 11 | mcs-PriorityAccess- |
| | | (MCData) | Data |
| 8 | 3 | Category 12 | mcs-PriorityAccess- |
| | | (MCVideo) | Video |
| 9 | 3 | Category 13 | mcs-PriorityAccess- |
| | | (MC_signaling) | signaling |

In an embodiment, a new standardized access category in combination with the legacy access identity is mapped to one new RRC establishment cause, the new standardized access category in combination with a new access identity is mapped to a different new RRC establishment cause.

In an example as shown in Table 11, a new access identity (access identity 3) is used together with a set of new access categories (10, 11, 12, and 13) to define a set of new RRC establishment causes; the legacy access identity (access identity 2) is also used together with the same set of new access categories (10, 11, 12, and 13) to define a different set of new RRC establishment causes. These two different sets of new RRC establishment causes are mapped to different priorities. For instance, the set of new RRC establishment causes associated to the access identity 2 is mapped to higher priority MC UEs/services, and the set of new RRC establishment causes associated to access identity 3 are mapped to lower priority MC UEs/Services.

Note that the legacy Rel-15/16 MC UEs will follow the legacy mapping table (Table 4), as the new release MC UEs and legacy MC UEs will have different RRC establishment cause values, the network node can distinguish the legacy MC UEs and new release MC UEs, therefore, no impact on legacy MC UE operations.

TABLE 11
Modified mapping table for access identities/access categories and
RRC establishment cause (legacy access identity with new access
categories, and new access identities with new access categories)

| | Access | | RRC establishment |
|---|---|---|---|
| Rule # | identities | Access categories | cause is set to |
| 1 | 1 | Any category | mps-PriorityAccess |
| 2 | 2 | Category 10 | mcs- |
| | | (MCPTT) | highPriorityAccess- |
| | | | PTT |
| 3 | 2 | Category 11 | mcs- |
| | | (MCData) | highPriorityAccess- |
| | | | Data |
| 4 | 2 | Category 12 | mcs- |
| | | (MCVideo) | highPriorityAccess- |
| | | | Video |
| 5 | 2 | Category 13 | mcs- |
| | | (MC_signaling) | highPriorityAccess- |
| | | | signaling |
| 6 | 11, 15 | Any category | highPriorityAccess |
| 7 | 12, 13, 14, | Any category | highPriorityAccess |
| 8 | 0 | 0 (=MT_acc) | mt-Access |
| | | 1 (=delay tolerant) | Not applicable |
| | | | (NOTE 1) |
| | | 2 (=emergency) | emergency |
| | | 3 (=MO_sig) | mo-Signalling |
| | | 4 (=MO MMTel | mo-VoiceCall |
| | | voice) | |
| | | 5 (=MO MMTel | mo-VideoCall |
| | | video) | |
| | | 6 (=MO SMS and | mo-SMS |
| | | SMSoIP) | |
| | | 7 (=MO_data) | mo-Data |
| | | 9 (=MO IMS | mo-Data |
| | | registration related | |
| | | signalling) | |
| 9 | 3 | Category 10 | mcs-PriorityAccess- |
| | | (MCPTT) | PTT |
| 10 | 3 | Category 11 | mcs-PriorityAccess- |
| | | (MCData) | Data |
| 11 | 3 | Category 12 | mcs-PriorityAccess- |
| | | (MCVideo) | Video |
| 12 | 3 | Category 13 | mcs-PriorityAccess- |
| | | (MC_signaling) | signaling |

2.3: Define Different Operator-Defined Access Categories for MC Services

In an embodiment, at least an operator-defined access category is defined for differentiating different MC services. In the case where a UE has already attached and received a Non-Access Stratum (NAS) message (e.g., a message originating from an Access and Mobility Function (AMF)) before entering RRC Idle state, an operator-defined access categories can be defined for differentiation between different MC Services.

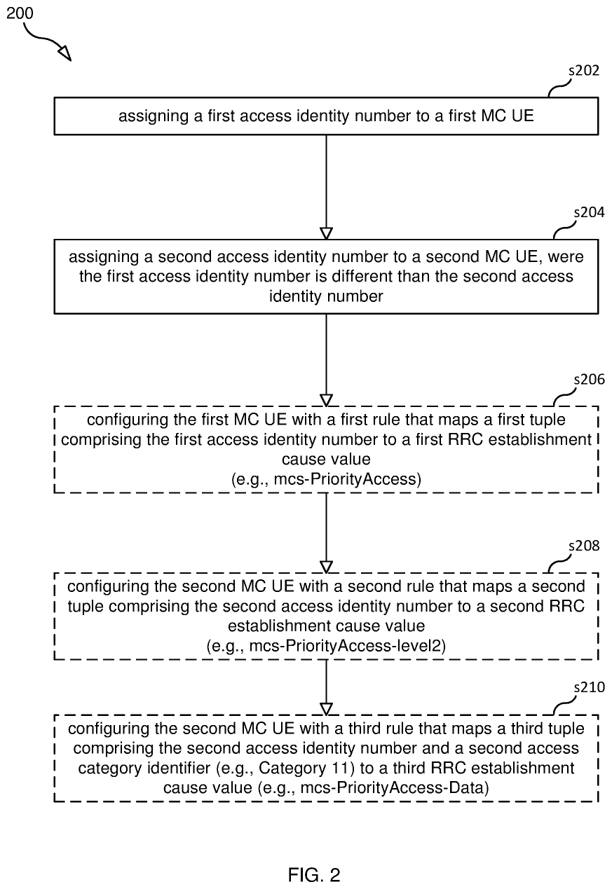

FIG. 2 is a flowchart illustrating a process 200, according to an embodiment, for configuring UEs. Process 200 may begin in step s202. Step s202 comprises assigning a first access identity number to a first UE (e.g., UE 102). Step s204 comprises assigning a second access identity number to a second MC UE, where the first access identity number is different than the second access identity number. In some embodiments, the first access identity is 2. In some embodiments, the second access identity number is an integer greater than 2 and less than 16. In some embodiments, the second access identity number is an integer greater than 10 and less than 16. In some embodiments, the second access identity number is an integer greater than 2 and less than 11. In some embodiments, the process further comprises configuring the first MC UE with a first rule that maps a first tuple comprising the first access identity number to a first Radio Resource Control (RRC) establishment cause value (e.g., mcs-PriorityAccess or mcs-PriorityAccess-level1); and configuring the second MC UE with a second rule that maps a second tuple comprising the second access identity number to a second RRC establishment cause value (e.g., mcs-PriorityAccess-level2), where the second RRC establishment cause value is different than the first RRC establishment cause value. In some embodiments, the second tuple further comprises a first access category identifier (e.g., Category 10). In some embodiments, the process further includes configuring the second MC UE with a third rule that maps a third tuple comprising the second access identity number and a second access category identifier (e.g., Category 11) to a third RRC establishment cause value (e.g., mcs-PriorityAccess-Data). In some embodiments, the second access category identifier is 8 or an integer greater than 9 and less than 32.

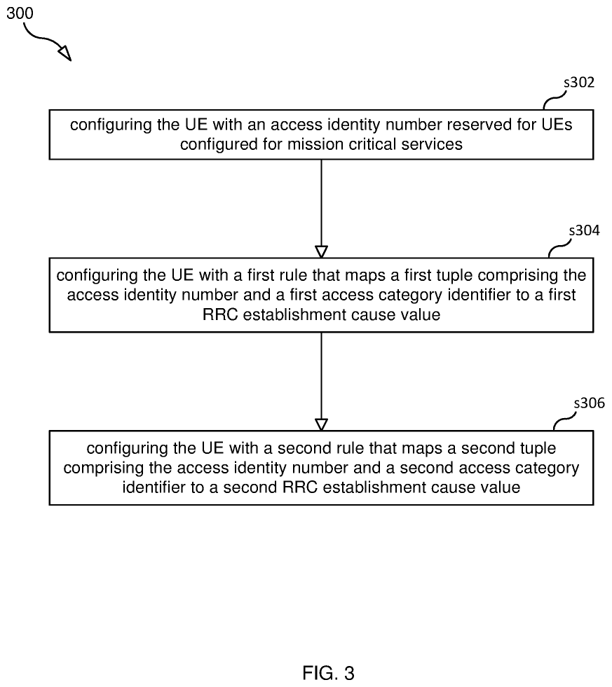

FIG. 3 is a flowchart illustrating a process 300, according to an embodiment, for configuring a UE (e.g., UE 102). Process 300 may begin in step s302. Step s302 comprises configuring the UE with an access identity number reserved for UEs configured for mission critical services (MCSs). Step s304 comprises configuring the UE with a first rule that maps a first tuple comprising the access identity number and a first access category identifier to a first RRC establishment cause value. Step s306 comprises configuring the UE with a second rule that maps a second tuple comprising the access identity number and a second access category identifier to a second RRC establishment cause value. The second access category identifier is different than the first access category identifier, and the second RRC establishment cause value is different than the first RRC establishment cause value.

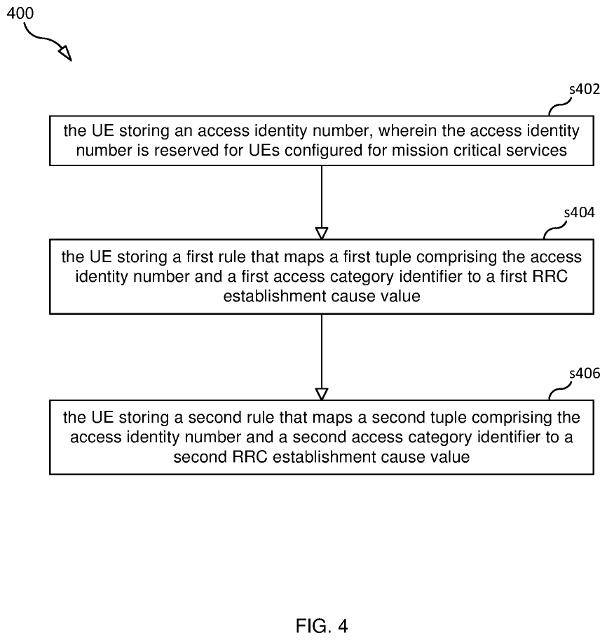

FIG. 4 is a flowchart illustrating a process 400 according to an embodiment. Process 400 may be performed by UE 102 and may begin in step s402. Step s402 comprises the UE storing an access identity number, wherein the access identity number is reserved for UEs configured for an MCS. Step s404 comprises the UE storing a first rule that maps a first tuple comprising the access identity number and a first access category identifier to a first Radio Resource Control, RRC, establishment cause value. Step s406 comprises the UE storing a second rule that maps a second tuple comprising the access identity number and a second access category identifier to a second RRC establishment cause value. The second access category identifier is different than the first access category identifier, and the second RRC establishment cause value is different than the first RRC establishment cause value.

In some embodiments, the access identity number is an integer greater than 1 and less than 11 (i.e., between and including 2-10). In some embodiments, the access identity number is 2. In some embodiments, the access identity number is greater than 2 and less than 11 (e.g., 3). In some embodiments, the first access category identifier is 8 or an integer greater than 9 and less than 32, and the second access category identifier is 8 or an integer greater than 9 and less than 32.

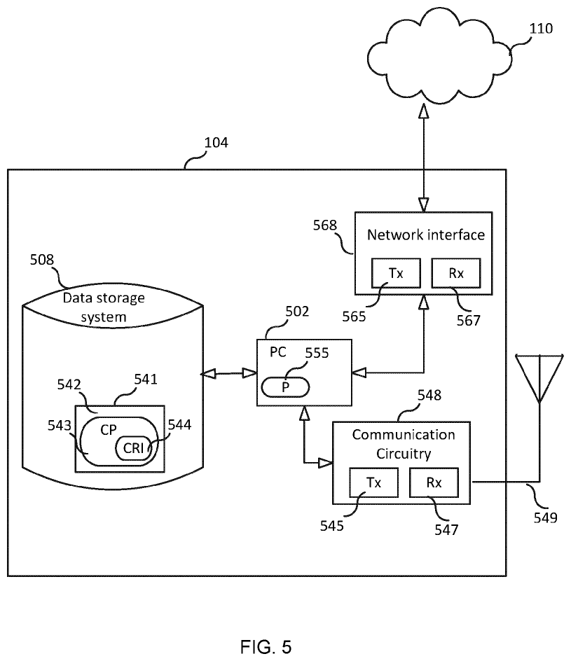

FIG. 5 is a block diagram of network node 104, according to some embodiments, for performing network node methods disclosed herein. As shown in FIG. 5, network node 104 may comprise: processing circuitry (PC) 502, which may include one or more processors (P) 555 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network node 104 may be a distributed computing apparatus); at least one network interface 568 comprising a transmitter (Tx) 565 and a receiver (Rx) 567 for enabling network node 104 to transmit data to and receive data from other nodes connected to a network 110 (e.g., an Internet Protocol (IP) network) to which network interface 568 is connected; communication circuitry 548, which is coupled to an antenna arrangement 549 comprising one or more antennas and which comprises a transmitter (Tx) 545 and a receiver (Rx) 547 for enabling network node 104 to transmit data and receive data (e.g., wirelessly transmit/receive data); and a local storage unit (a.k.a., “data storage system”) 508, which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes network node 104 to perform steps described herein (e.g., steps described herein with reference to the flow charts). In other embodiments, network node 104 may be configured to perform steps described herein without the need for code. That is, for example, PC 502 may consist merely of one or more ASICs. Hence, the features of the embodiments described herein may be implemented in hardware and/or software.

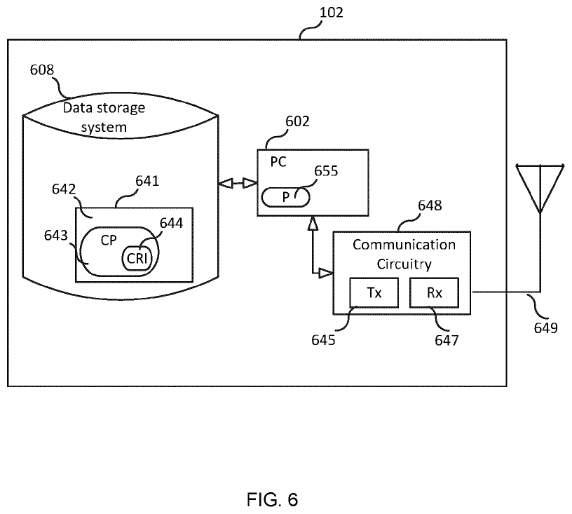

FIG. 6 is a block diagram of UE 102, according to some embodiments. As shown in FIG. 6, UE 102 may comprise: processing circuitry (PC) 602, which may include one or more processors (P) 655 (e.g., one or more general purpose microprocessors and/or one or more other processors, such as an application specific integrated circuit (ASIC), field-programmable gate arrays (FPGAs), and the like); communication circuitry 648, which is coupled to an antenna arrangement 649 comprising one or more antennas and which comprises a transmitter (Tx) 645 and a receiver (Rx) 647 for enabling UE 102 to transmit data and receive data (e.g., wirelessly transmit/receive data); and a local storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes UE 102 to perform steps described herein (e.g., steps described herein with reference to the flow charts). In other embodiments, UE 102 may be configured to perform steps described herein without the need for code. That is, for example, PC 602 may consist merely of one or more ASICs. Hence, the features of the embodiments described herein may be implemented in hardware and/or software.

### SUMMARY OF VARIOUS EMBODIMENTS

A1. A method for configuring user equipments, UEs, the method comprising: assigning a first access identity number to a first mission critical, MC, UE; and assigning a second access identity number to a second MC UE, wherein the first access identity number is different than the second access identity number.
A2. The method of embodiment A1, wherein the first access identity is 2.
A3. The method of embodiment A1 or A2, wherein the second access identity number is an integer greater than 2 and less than 16.
A4. The method of embodiment A3, wherein the second access identity number is an integer greater than 10 and less than 16.
A5. The method of embodiment A3, wherein the second access identity number is an integer greater than 2 and less than 11.
A6. The method of embodiment A5, further comprising: configuring the first MC UE with a first rule that maps a first tuple comprising the first access identity number to a first Radio Resource Control, RRC, establishment cause value (e.g., mcs-PriorityAccess or mcs-PriorityAccess-level1); and configuring the second MC UE with a second rule that maps a second tuple comprising the second access identity number to a second RRC establishment cause value (e.g., mcs-PriorityAccess-level2), wherein the second RRC establishment cause value is different than the first RRC establishment cause value.
A7. The method of embodiment A6, wherein the second tuple further comprises a first access category identifier (e.g., Category 10).
A8. The method of embodiment A7, further comprising: configuring the second MC UE with a third rule that maps a third tuple comprising the second access identity number and a second access category identifier (e.g., Category 11) to a third RRC establishment cause value (e.g., mcs-PriorityAccess-Data).
A9. The method of embodiment A7 or A8, wherein the second access category identifier is 8 or an integer greater than 9 and less than 32.
B1. A method for configuring a user equipment, UE, the method comprising: configuring the UE with an access identity number reserved for UEs configured for mission critical services, MCSs; configuring the UE with a first rule that maps a first tuple comprising the access identity number and a first access category identifier to a first Radio Resource Control, RRC, establishment cause value; and configuring the UE with a second rule that maps a second tuple comprising the access identity number and a second access category identifier to a second RRC establishment cause value, wherein the second access category identifier is different than the first access category identifier, and the second RRC establishment cause value is different than the first RRC establishment cause value.
B2. A method performed by a user equipment, UE, the method comprising: the UE storing an access identity number, wherein the access identity number is reserved for UEs configured for mission critical services, MCSs; the UE storing a first rule that maps a first tuple comprising the access identity number and a first access category identifier to a first Radio Resource Control, RRC, establishment cause value; and the UE storing a second rule that maps a second tuple comprising the access identity number and a second access category identifier to a second RRC establishment cause value, wherein the second access category identifier is different than the first access category identifier, and the second RRC establishment cause value is different than the first RRC establishment cause value.
B3. The method of embodiment B1 or B2, wherein the access identity number is an integer greater than 1 and less than 11 (i.e., between and including 2-10).
B4. The method of embodiment B1 or B2, wherein the access identity number is 2.
B5. The method of embodiment B3, wherein the access identity number is greater than 2 and less than 11 (e.g., 3).
B6. The method of any one of embodiments B1-B5, wherein the first access category identifier is 8 or an integer greater than 9 and less than 32, and the second access category identifier is 8 or an integer greater than 9 and less than 32.
C1. A computer program comprising instructions which when executed by processing circuitry of a network node causes the network node to perform the method of any one embodiments A1-A9, B1, or B3-B6.
C2. A computer program comprising instructions which when executed by processing circuitry of a user equipment, UE, causes the UE to perform the method of any one embodiments B2-B6.
C3. A carrier containing the computer program of embodiment C1 or C2, wherein the carrier is one of an electronic signal, an optical signal, a radio signal, and a computer readable storage medium (542, 642).
D1. A network node, the network node being adapted to perform the method of any one of embodiments A1-A9, B1, or B3-B6.
E1. A network node, the network node comprising: processing circuitry; and a memory, the memory containing instructions executable by the processing circuitry, whereby the network node is operative to perform the method of any one of the embodiments A1-A9, B1, or B3-B6.
F1. A user equipment, UE, the UE being adapted to perform the method of any one of embodiments B2-B6.
G1. A user equipment, UE, the UE comprising: processing circuitry; and a memory, the memory containing instructions executable by the processing circuitry, whereby the UE is operative to perform the method of any one of the embodiments B2-B6.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for configuring user equipments (UEs), the method comprising:
assigning a first access identity number to a first mission critical (MC) UE; and
assigning a second access identity number to a second MC UE, wherein
the first access identity number is different than the second access identity number.

2. The method of claim 1, wherein
the first access identity is 2, and/or
the second access identity number is an integer greater than 2 and less than 16.

3. (canceled)

4. The method of claim 2, wherein the second access identity number is an integer greater than 10 and less than 16.

5. The method of claim 2, wherein the second access identity number is an integer greater than 2 and less than 11.

6. The method of claim 5, further comprising:
configuring the first MC UE with a first rule that maps a first tuple comprising the first access identity number to a first Radio Resource Control (RRC) establishment cause value; and
configuring the second MC UE with a second rule that maps a second tuple comprising the second access identity number to a second RRC establishment cause value, wherein
the second RRC establishment cause value is different than the first RRC establishment cause value.

7. The method of claim 6, wherein
the second tuple further comprises a first access category identifier.

8. The method of claim 7, further comprising:
configuring the second MC UE with a third rule that maps a third tuple comprising the second access identity number and a second access category identifier to a third RRC establishment cause value.

9. The method of claim 7, wherein the second access category identifier is 8.

10. (canceled)

11. A method for configuring a user equipment (UE), the method comprising:
configuring the UE with an access identity number reserved for UEs configured for mission critical services (MCSs);
configuring the UE with a first rule that maps a first tuple comprising the access identity number and a first access category identifier to a first Radio Resource Control (RRC) establishment cause value; and
configuring the UE with a second rule that maps a second tuple comprising the access identity number and a second access category identifier to a second RRC establishment cause value, wherein
the second access category identifier is different than the first access category identifier, and
the second RRC establishment cause value is different than the first RRC establishment cause value.

12. A method performed by a user equipment, UE, the method comprising:
the UE storing an access identity number, wherein the access identity number is reserved for UEs configured for mission critical services (MCSs);
the UE storing a first rule that maps a first tuple comprising the access identity number and a first access category identifier to a first Radio Resource Control (RRC) establishment cause value; and
the UE storing a second rule that maps a second tuple comprising the access identity number and a second access category identifier to a second RRC establishment cause value, wherein
the second access category identifier is different than the first access category identifier, and
the second RRC establishment cause value is different than the first RRC establishment cause value.

13. The method of claim 12, wherein the access identity number is an integer greater than 1 and less than 11.

14. The method of claim 12, wherein the access identity number is 2.

15. The method of claim 13, wherein the access identity number is greater than 2 and less than 11.

16. The method of claim 12, wherein
the first access category identifier is 8 or an integer greater than 9 and less than 32, and
the second access category identifier is 8 or an integer greater than 9 and less than 32.

17. A non-transitory computer readable storage medium storing a computer program comprising instructions which when executed by processing circuitry of a network node causes the network node to perform the method of claim 1.

18. A non-transitory computer readable storage medium storing a computer program comprising instructions which when executed by processing circuitry of a user equipment (UE) causes the UE to perform the method of claim 12.

19. (canceled)

20. A network node, the network node comprising:
processing circuitry; and
a memory, the memory containing instructions executable by the processing circuitry, wherein the network node is configured to perform the method of claim 1.

21. (canceled)

22. A network node, the network node comprising:
processing circuitry; and
a memory, the memory containing instructions executable by the processing circuitry, wherein the network node is configured to perform the method of claim 11.

23. (canceled)

24. (canceled)

25. A user equipment (UE), the UE comprising:
processing circuitry; and
a memory, the memory containing instructions executable by the processing circuitry, wherein the UE is configured to perform the method of claim 12.

26. (canceled)

27. (canceled)

28. A non-transitory computer readable storage medium storing a computer program comprising instructions which when executed by processing circuitry of a network node causes the network node to perform the method of claim 11.
